(19) United States
(12) Patent Application Publication
(10) Pub. No.: US 2006/0236816 A1
(43) Pub. Date: Oct. 26, 2006

(54) Tool for fastening connectors to printed circuit boards

(76) Inventor: Mike Picou, Blue Ridge, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/112,575

(22) Filed: Apr. 22, 2005

(51) Int. Cl. B25B 17/00

(52) U.S. Cl. 81/57.14; 81/57.3

(57) ABSTRACT

Embodiments include apparatus and methods for fastening connectors to a printed circuit board (PCB). One exemplary embodiment includes a tool for fastening connectors on the PCB. The tool has a body having first and second ends. The first end includes an engaging region adapted to fasten electrical connectors on the PCB. An elongated handle extends perpendicular from the body. A torque transmitting assembly is housed in the body and transmits a rotational force from the handle to a gear located in the engaging region.

### BACKGROUND

Printed circuit boards (PCBs) are used to form many complex electronic devices and systems. Many of these PCBs have numerous electronic components and electrical traces extending between these components. Before the PCBs are mass-produced, extensive testing of the board, components, and electrical traces is performed.

One way to perform testing is to physically connect various locations on the PCB to a testing device. In some instances, electrical connectors are soldered to one side of the PCB. A coax cable connects to the connector and provides an electrical link to the testing device. Soldered connectors are reliable and offer electrical contact points for signal transmissions to and from the PCB. For example, coax cables can be repeatedly connected and disconnected from the soldered connector without damaging the PCB or the connectors.

In order to establish electrical connection with the connectors, one end of the coax cable is manually attached to the connector. In some instances, the coax cable has a female connector that must be threaded onto exterior threads on the end of the connector. A user is required to grip an end of the coax cable and hand-tighten or thread each cable to a respective connector soldered to the PCB.

Establishing the connection between the coax cable and connector can be difficult. The electrical connectors are small and can have widths less than one-half inch or even one-quarter inch. Thus, it is difficult to grab the cable and screw it onto a connector. Further, in some situations, many electrical connectors are soldered to the PCB. Multiple rows and columns of connectors can extend along the PCB and provide electrical access points for the testing devices. The space between adjacent connectors can be too small for fingers to maneuver easily and attach the cable to the connector.

### BRIEF DESCRIPTION OF THE DRAWINGS

FIG. 1 is a plan view of an exemplary PCB connected to a testing device in accordance with the present invention.

FIG. 2 is a side view of a PCB with multiple connectors and an exemplary tool to mount the connectors in accordance with the present invention.

FIG. 3 is a partial cross-sectional view of an exemplary tool for mounting connectors to a PCB in accordance with the present invention.

FIG. 4 is an enlarged plan view of a head of a tool showing an exemplary torque transmitting assembly in accordance with the present invention.

FIG. 5 is a perspective view of an exemplary slotted gear of the torque transmitting assembly in accordance with the present invention.

FIG. 6 is a perspective view of another exemplary tool in accordance with the present invention.

FIG. 7 shows a side view of the tool of FIG. 6 engaging a connector in accordance with the present invention.

### DETAILED DESCRIPTION

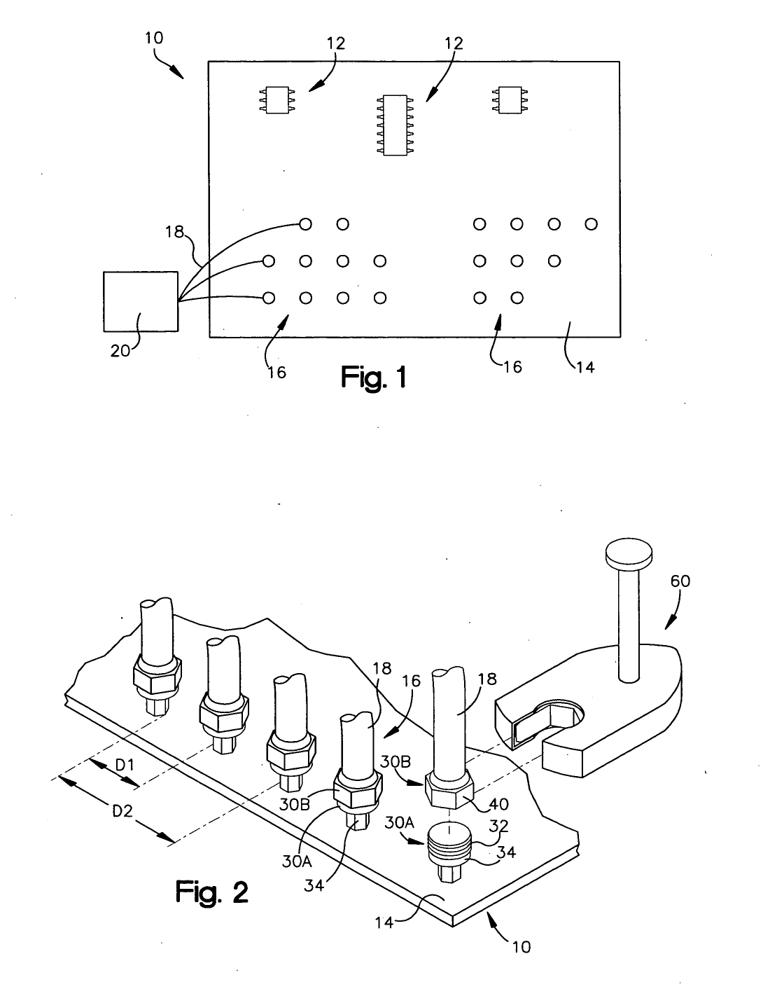

FIG. 1 illustrates a printed circuit board (PCB) 10 having various electrical components 12 connected to one side 14 of the PCB 10. Plural electrical connectors 16 are connected to the PCB. For illustration, some of the electrical connectors 16 are connected to a line or cable 18 that connects to a testing device 20.

The PCB 10 can have a variety of configurations. By way of example, PCBs include a substrate or insulator on which various electronic components are placed and electrically connected with plural printed wires or traces. PCBs include, but are not limited to, motherboards (example, boards with connectors for attaching components to a bus), daughterboards (example, boards that attach to another board), expansion boards (example, any board that connects to an expansion slot), controller boards (example, boards for controlling a peripheral device), network interface cards (example, boards that enable a computer to connect to a network), and video adapters (example, boards that control a graphics monitor).

The testing device 20 can have a variety of configurations. By way of example, the testing device 20 includes electronic equipment for transmitting and receiving electrical signals that test the PCB 10, traces, and/or electronic components 12.

The cables 18 provide a conductive pathway from the PCB 10 to another location, such as the testing device 20. As used herein, the term “cable” means any physical line, metal or non-metal, that conducts electricity.

FIG. 2 shows the PCB 10 having numerous connectors 16 connected to one side 14 of the PCB 10. The connectors 16 are used, for example, to electrically couple the PCB 10 and/or components 12 to the testing device 20. The connectors 16 provide a mechanical and electrical interface or connection to the PCB. As used herein, a “connector” is any device that provides a conductive pathway for joining electrical circuits or components.

In one exemplary embodiment, the connectors 16 include two separate components 30A and 30B. For example, one component includes a socket (female), and the other component includes a plug (male) that is removably and repeatedly connectable to the socket.

For illustration purposes, the component 30A has a body with external threads 32. The body, for example, is formed from an insulating polymer with a metal conductive insert that is coaxial with the body. A plurality of conductive pins 34 extend outwardly from a lower portion of the body. The pins 34 are parallel, symmetrically arranged, and formed from a rigid metal. The pins 34 are formed from any material that provides rigidity and strength sufficient to maintain mechanical and electrical connection between cable 18 and PCB 10.

The component 30A can be connected to the PCB 10 in a variety of ways. In one embodiment, the pins 34 are soldered to the PCB. As another example, the PCB 10 can have through holes or vias (example, conductive throughways) to receive an end of the pins. A force-fit or adhesive can also be used to secure the component 30A to the PCB.

For illustration purposes, the component 30B has a body with an external tool engaging configuration 40. A cable 18 extends outwardly from one end of the body. The tool engaging configuration 40 is shaped and configured to engage tool 60. By way of example, the tool engaging configuration 40 includes, but is not limited to, circles, squares, triangles, hexagons, octagons, stars, and other polygonal shapes. Further, the component 30B has internal threads (not shown) for threadably mating with the external threads 32 of component 30A.

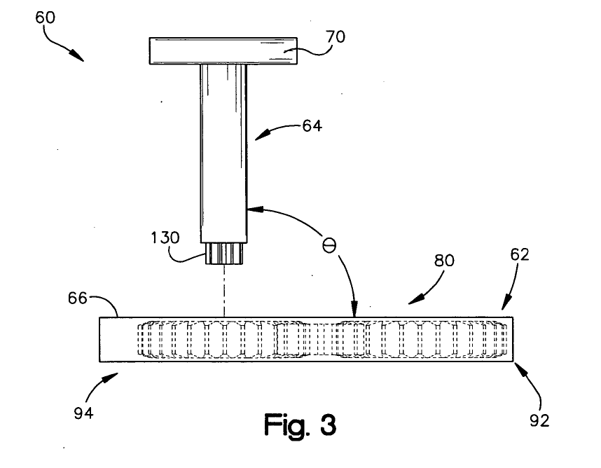

FIGS. 3-5 illustrate the tool 60 in more detail. The tool 60 has a body or head 62 and a handle or shaft 64 that extends outwardly from one surface 66 (such as a top outer surface) of the body 62. By way of example, the handle 64 has an elongated cylindrical shape with two ends. A first end (distal from the body 62) includes a knob or rotation wheel 70. A second end (proximal to the body 62) is mechanically connected to a torque transmitting assembly 80. Rotation of the knob 70 actuates or moves the torque transmitting assembly 80.

In one exemplary embodiment, the handle 64 and surface 66 of the body 62 are formed at an angle Ø. In one exemplary embodiment, this angle is ninety degrees. In this configuration, the handle 64 is perpendicular with the body 62 such that a portion of the handle 64 (including the knob 70) is located above the connector while the tool 60 is engaged with a connector. A user is thus able to grab and rotate knob 70 without physically handling the plural connectors connected to the PCB. A connector can be connected, unconnected, tightened, or loosened with the tool while the hands of the user are completely above the PCB and connectors.

The tool 60 is adapted to engage or grip a connector 16 in order to fasten or unfasten a connector to the PCB 10. In this regard, the body 62 includes an engaging region 90 disposed at one end 92 of the body. A second end 94, opposite the end 92, includes the handle 64.

The engaging region 90 engages or grips the outer surface or tool engaging configuration 40 of component 30B. In one exemplary embodiment, the engaging region 90 is shaped to engage a variety of differently shaped connectors. For example, the tool engaging region 90 is formed as a recess, slot, or opening having a configuration such as, but not limited to, circles, triangles, squares, pentagon, hexagons, octagons, stars, and other polygonal shapes.

The torque transmitting assembly 80 includes any mechanical assembly that transmits torque from one mechanical device to another mechanical device. By way of example, the torque transmitting assembly is a gear assembly that includes plural gears that engagingly move upon actuation of handle 64 (example rotation of knob 70). Embodiments in accordance with the present invention include a variety of configurations of gear assemblies. By way of example, the gear assembly includes four different gears 100A-100D. As used herein, a “gear” is a toothed wheel or device that transmits torque to another gear, toothed wheel, or device.

In one exemplary embodiment, each gear 100A-100D has a circular or wheel shaped body with a plurality of teeth 110 that project outwardly from the body. The teeth of adjacent gears rotationally engage to transfer torque from the handle 64 to the engaging region 90. In one exemplary embodiment, torque is transmitted from the handle 64 to the gear assembly using a gear 130 (FIG. 3) on an end of the handle. The gear 130 has a plurality of teeth that are shaped and sized to engage with corresponding teeth 136 in an opening 138 of gear 100A.

Differently sized and shaped gears (or gear ratios) can be used to produce different degrees of torque and/or rotational speed. For example, the gear 100D is larger than gears 100A-100C. In one exemplary embodiment, gear 100D has a slot, recess, or opening 120. The slot 120 and the end portion of the body 62 form the engaging region 90.

Various types of gears can be used in embodiments in accordance with the invention. These types of gears include, but are not limited to, spur gears (teeth radially project in a plane of the wheel portion), helical gears (teeth are cut at an angle), double helical gears (teeth are cut in a “V” shape), beveled gears (angled teeth that enable torque to be transmitted between non-parallel but intersecting axles), a crown gear (teeth at right angles to the plane of the wheel portion), and worm gears, to name a few examples. Further, each gear can have a similar or different size.

Rotation of the handle 64 causes gear 100A to rotate. This rotation, in turn, causes gears 100B and 100C to rotate. Rotation of gears 100B and 100C, in turn, causes gear 100D to rotate. Rotation of gear 100D enables torque or rotational force to be transmitted to the connectors 16. For example, when a body of a connector 16 (such as tool engaging configuration 40 of component 30B) is positioned or engaged inside slot 120, the connector 16 is rotated upon rotation or actuation of handle 64. Component 30B can be threaded and unthreaded onto component 30A with the tool 60.

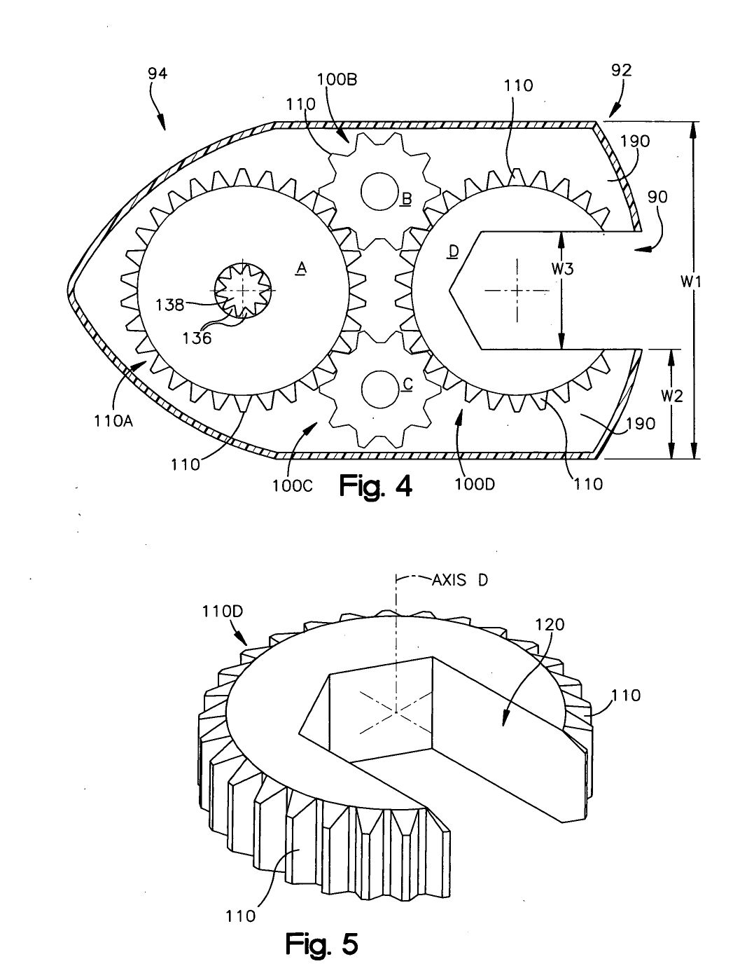

In one exemplary embodiment, gears 100A-100C form a triangular configuration (see FIG. 4). Each gear has a central axis or center point labeled A-D, respectively. The axes are parallel with each other and handle 64 and extend perpendicular with the surface 66 of body 62. FIG. 5 shows axis D for gear 100D (i.e., the slotted gear for engaging the connector). The axis D aligns with the axis A of gear 100A. Further, the axis D is positioned between the axes B and C.

In one exemplary embodiment, end 92 of body 62 has a fork shape. As best shown in FIG. 4, the body 62 has two arms or extensions 190 that form sides or walls to the engaging region 90. End 92 of body 62 has an overall width or dimension equal to W1, and each extension has a width or dimension equal to W2. Looking also to FIG. 2, the connectors 16 are spaced such that the distance between two adjacent connectors is D1, and an inner distance between three connectors is D2. In one exemplary embodiment, W2<D1, and W1<D2. Thus, the end 92 is sized to engage one connector in engaging region 90 while each extension 190 fits between a space between two adjacent connectors.

As best shown in FIG. 4, the opening or slot 120 has a width or dimension W3. Preferably, this dimension W3 is smaller than a gear engaging region of both gears 100B and 100C. As gear 100D rotates within body 62, the slot 120 passes across the teeth 100 of gears 100B and 100C (i.e., the gear engaging region). The slot 120 is shaped and size such that at least one tooth from the gear 100D remains in engagement with at least one tooth from gear 100B and/or 100C in order to maintain torque transmission from handle 64 to gear 110D.

The gears 100A-100D can be maintained or housed within the body 62 using any one of a variety of techniques. By way of example, a circular channel or groove is provided on top and/or bottom sides of the body portion of the gears. These grooves mate with corresponding raised shoulders or extensions along the inner side or surface of the body 62 so the gears can freely rotate yet not otherwise move inside the body 62. As another example, some of the gears can be provided with central recesses to receive a pin that protrudes from the inner surface of the body 62.

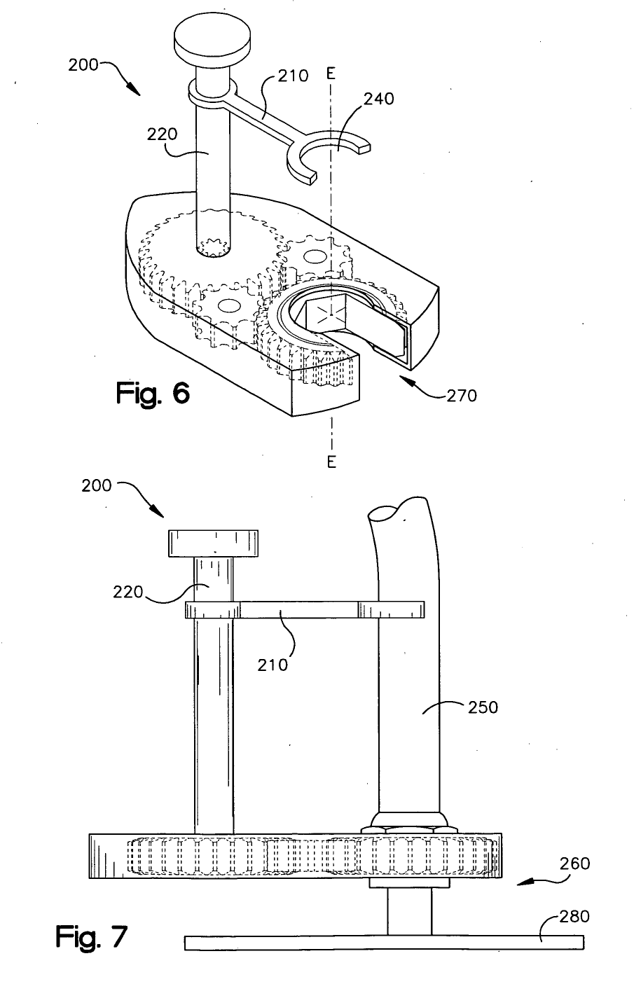

FIGS. 6 and 7 show another example of a tool 200 in accordance with embodiments of the invention. Tool 200 is similarly configured to tool 60. As one difference, tool 200 includes an extension 210 that extends outwardly at a ninety degree angle with handle 220. One end of the extension 210 includes an opening 240 that is shaped and sized to receive and capture the cable 250 that extends from a connector 260.

In one exemplary embodiment, the extension 210 has a length so the opening 240 aligns with the engaging region 270. Axis E illustrates this alignment. When the tool 200 is engaged with connector 260, the cable 250 is maintained in a vertical and parallel relationship with the handle 220. As such, the cable extends upwardly in a perpendicular direction with respect to the PCB 280.

In one embodiment, the extension 210 maintains the cable 250 at a fixed distance from the tool 200 during installation or removal of the connector 260. The cable 250 is less likely to get tangled with the tool or other cables extending from the PCB 280.

While the invention has been disclosed with respect to a limited number of embodiments, those skilled in the art will appreciate, upon reading this disclosure, numerous modifications and variations. It is intended that the appended claims cover such modifications and variations and fall within the true spirit and scope of the invention.

1. A tool for fastening connectors on a printed circuit board, the tool comprising:
a body having first and second ends, the first end including an engaging region adapted to fasten electrical connectors on a printed circuit board (PCB);
an elongated handle extending perpendicular from the body;
a torque transmitting assembly housed in the body and transmitting a rotational force from the handle to a gear located in the engaging region; and
an extension connected to and extending from the handle, the extension having an end for aligning a cable tat extends tom a connector on the PCB.

2. The tool of claim 1, wherein the second end is oppositely disposed from the first end, and the handle extends from the second end.

3. The tool of claim 1, wherein the gear has a slot that is shaped and sized to receive one of the electrical connectors.

4. The tool of claim 1, wherein the handle has one end with gears that engage the torque transmitting assembly for transmitting the rotational force from the handle.

5. The tool of claim 1, wherein the torque transmitting assembly includes four separate gears, wherein a first gear rotationally engages with the handle and a second gear rotationally engages with one of the electrical connectors.

6. The tool of claim 1, wherein the handle has a distal end from the body, the distal end having a rotatable knob for generating the rotational force from the handle.

7. The tool of claim 1, wherein the torque transmitting assembly includes gears arranged in a triangular configuration.

8. A tool for engaging connectors on a printed circuit board, the tool comprising:
a body having one end with an end region that engages electrical connectors on a printed circuit board (PCB);
a handle extending perpendicular from the body and including a gear at one end;
a gear assembly located in the body and including a plurality of circular gears, wherein the gear of the handle engages the gear assembly for transmitting torque from the handle to the engaging regions; and
an extension extending from the handle to align a cable that extends from an electrical connector on the PCB.

9. The tool of claim 8, wherein the one end of the body has a forked shape with two extensions that form the engaging region.

10. The tool of claim 8, wherein the one end of the body has two extensions, each extension has a width that is smaller than a space between two adjacent connectors on the PCB.

11. The tool of claim 8, wherein one of the circular gears has an opening with interior teeth extending into the opening to engage the gear at the one end of the handle.

12. The tool of claim 8, wherein the gear assembly includes four circular gears, a first gear engaging the handle, a second gear having a slot forming the engaging region, and third and fourth gears disposed between the first and second gears.

13. The tool of claim 8, wherein one of the circular gears is a slotted gear that includes a slot that passes over teeth of two other gears while the slotted gear remains engaged with the two other gears.

14. The tool of claim 8, wherein the body has a flat bottom surface positioned adjacent a surface of the PCB while the engaging region engages the electrical connector on the PCB.

15. The tool of claim 8, wherein one of the circular gears has an opening that defines the engaging region.

16. A method for fastening connectors on a printed circuit board, the method comprising:
engaging an opening in one end of a body of a tool with a first component of a connector;
engaging the first component with a second component of the connector, the second component being connected to a printed circuit board (PCB);
using an extension on the handle to align a cable parallel with the handle, the cable extending from the first component; and
rotating a handle extending perpendicular from the body to transmit torque from the handle to the opening in order to threadably engage the first component with the second component.

17. The method of claim 16 further comprising positioning a flat surface of the body adjacent a surface of the PCB in order to engage the opening with the first component.

18. The method of claim 16 further comprising rotating a knob on an end of the handle to generate the torque.

19. The method of claim 16 further comprising transmitting the torque from the handle to at least three gears located in the body.

20. The method of claim 16 further comprising positioning the one end of the body between adjacent connectors on the PCB and threadably tightening the first component to the second component.
